(19) United States
(12) Patent Application Publication
(10) Pub. No.: US 2024/0205549 A1
(43) Pub. Date: Jun. 20, 2024

(54) IMAGING DEVICE

(71) Applicant: NIDEC PRECISION CORPORATION, Tokyo (JP)

(72) Inventor: Yuusuke SUZUKI, Tokyo (JP)

(21) Appl. No.: 18/534,737

(22) Filed: Dec. 11, 2023

(30) Foreign Application Priority Data
Dec. 20, 2022 (JP) 2022-203552

(51) Int. Cl. H04N 23/75; H04N 23/71

(52) U.S. Cl. CPC H04N 23/75; H04N 23/71

(57) ABSTRACT

An imaging device includes a housing, an imaging element accommodated in the housing to receive subject light through an optical member, an illuminometer accommodated in the housing to receive external light through a sound collecting opening in the housing and detect brightness of a surrounding environment, and a light shield surrounding the illuminometer and filling a space between a substrate on which the illuminometer is mounted and the housing to block light.

### RELATED APPLICATIONS

The present application claims priority to Japanese Application Number 2022-203552, filed Dec. 20, 2022, the disclosure of which is hereby incorporated by reference herein in its entirety.

### BACKGROUND

### Technical Field

The present invention relates to an imaging device.

### Description of the Background

Surveillance cameras are installed at various places such as nursing care facilities, hospitals, factories, and stores for crime and disaster prevention. Such surveillance cameras, which are imaging devices, may be used in dark environments such as a room receiving no direct or indirect sunlight and a room with no lightening equipment being on.

Patent Literature 1 describes a private room monitoring system. The system includes a sensor unit with an optical block including projectors that project infrared laser beams into a room, a light-emitting diode (LED) diffused light illuminator that emits infrared light to the room as illumination light, an imaging device that captures images of the room, and an illuminometer. To obtain images, the imaging device captures an image of a group of bright spots projected into the room by the projectors and also captures an image of the room illuminated by the LED diffused light illuminator. The illuminometer is located adjacent to the imaging device. In response to the illuminometer receiving the amount of light exceeding a predetermined value due to ambient light, the sensor unit provides a notification indicating that monitoring cannot be performed normally.

### CITATION LIST

### Patent Literature

Patent Literature 1: WO 2018/038087

### BRIEF SUMMARY

Illuminometers may basically measure the amount of light entering through the front surface. However, the structure described in Patent Literature 1 may allow light to enter the illuminometer through an area around the side surface of the illuminometer. This may not allow accurate measurement of illuminance, possibly causing errors.

An imaging device according to an aspect of the present invention includes a housing, an imaging element accommodated in the housing to receive subject light through an optical member, an illuminometer accommodated in the housing to receive external light through an opening in the housing and detect brightness of a surrounding environment, and a light shield surrounding the illuminometer and filling a space between a substrate on which the illuminometer is mounted and the housing to block light.

An imaging device according to another aspect of the present invention includes a housing, an imaging element accommodated in the housing to receive subject light through an optical member, an illuminometer accommodated in the housing to receive external light through an opening in the housing and detect brightness of a surrounding environment, a light shield surrounding the illuminometer and filling a space between a substrate on which the illuminometer is mounted and the housing to block light, an illuminator that emits illumination light to illuminate a subject, and a light-transmissive filter between the housing and the illuminometer. The illuminator is farther from the subject than the illuminometer in a direction along an optical axis of the optical member. The light shield is formed from an elastic material. The light shield has a length in the direction along the optical axis greater than a distance between the housing and the substrate in the direction along the optical axis. The light shield accommodated in the housing is deformed by the housing and the substrate in the direction along the optical axis. The light shield has an elongated through-hole through which external light traveling in the direction along the optical axis passes after passing through the opening in the housing.

The imaging device according to the above aspects of the present invention can reduce entry of light through an area around the side surface of the illuminometer and improve the measurement accuracy of the illuminometer.

### BRIEF DESCRIPTION OF DRAWINGS

FIG. 1 is an external perspective view of an imaging device according to an embodiment.

FIG. 2 is an external perspective view of a front case.

FIG. 3 is an internal perspective view of the imaging device.

FIG. 4 is a cross-sectional view of the imaging device taken along line A-A in FIG. 1.

FIG. 5 is a cross-sectional view of the imaging device taken along line B-B in FIG. 1.

FIG. 6A is a partially enlarged view of the external perspective view of FIG. 2.

FIG. 6B is a partially enlarged view of the cross-sectional view of FIG. 4.

FIG. 7 is a partially enlarged view of the cross-sectional view of FIG. 5.

### DETAILED DESCRIPTION

An imaging device according to one or more embodiments of the present invention will now be described in detail with reference to the drawings.

The imaging device may have any use and may be installed at, for example, a hospital, a nursing care facility, a factory, and a store as a surveillance camera or as a monitoring camera. The imaging device detects the brightness of the surrounding external environment with an illuminometer and can be switched between a normal imaging mode and a low-light imaging mode based on the detected brightness. Imaging in the normal imaging mode is performed using light incident on an imaging optical system when the external environment is bright. Imaging in the low-light imaging mode is performed using illumination light emitted when the external environment is dark to allow imaging of a subject using the illumination light.

### Overall Structure of Imaging Device 10

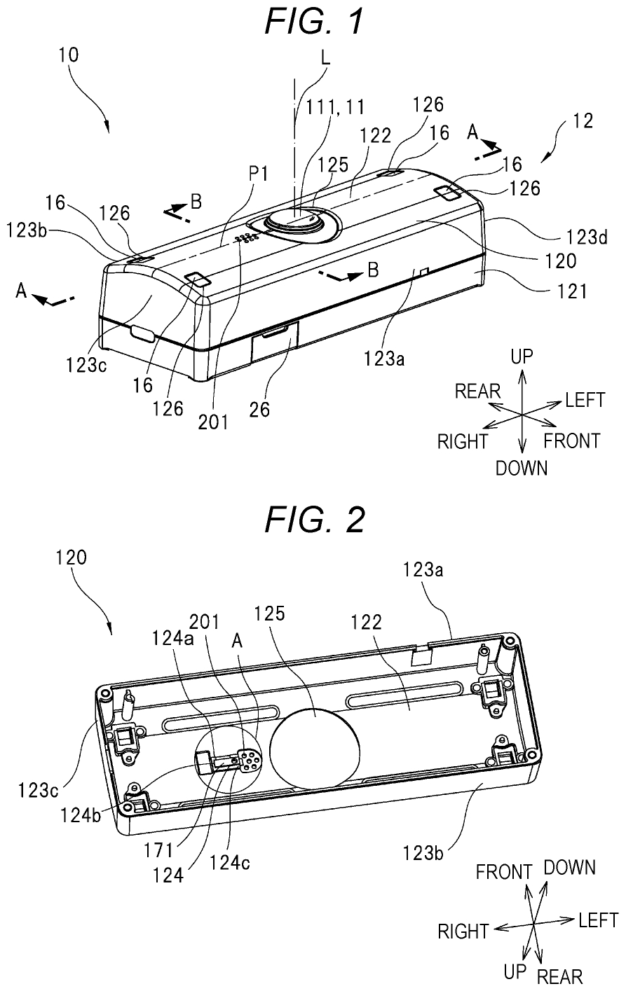

FIG. 1 is an external perspective view of an imaging device 10. The imaging device 10 includes a camera module 11, a housing (outer case) 12, illuminators 16, and a memory slot 26.

### Housing 12

The housing 12 includes a front case 120 and a rear case 121. The front case 120 includes a rectangular or substantially rectangular top plate 122 and sidewall plates 123a, 123b, 123c, and 123d that adjoin the sides of the top plate 122. The top plate 122 and the sidewall plates 123a, 123b, 123c, and 123d are integrally formed from a synthetic resin. The sidewall plate 123a adjoins one long side of the top plate 122. The sidewall plate 123b adjoins the other long side of the top plate 122. The sidewall plate 123c adjoins one short side of the top plate 122. The sidewall plate 123d adjoins the other short side of the top plate 122.

Hereafter, the direction in which the front case 120 in the housing 12 is located may be referred to as being upward, the direction in which the rear case 121 is located as being downward, the direction in which the sidewall plate 123a is located as being frontward, the direction in which the sidewall plate 123b is located as being rearward, the direction in which the sidewall plate 123c is located as being rightward, and the direction in which the sidewall plate 123d is located as being leftward.

The top plate 122 of the front case 120 is an outer plate intersecting with an optical axis L of a lens 111 included in the camera module 11. The top plate 122 includes a middle portion (in other words, a first reference position P1) protruding upward with respect to its front and rear ends in the front-rear direction.

The top plate 122 has a case opening 125 and four illumination openings 126. The case opening 125 has a circular or substantially circular shape centered on a point through which the optical axis L of the lens 111 extends. The lens 111 (described later) is placed in the case opening 125. In the present embodiment, the optical axis L of the lens 111 extends through the center of the top plate 122.

The optical axis L of the lens 111 may not extend through the center of the top plate 122. The optical axis L of the lens 111 may extend through a point shifted rightward or leftward from the center of the top plate 122, or may extend through a point shifted frontward or rearward from the center of the top plate 122.

The top plate 122 has the illumination openings 126 in its four corners. The illumination openings 126 allow passage of illumination light emitted from the illuminators 16 (described later) in the housing 12 outside the imaging device 10. As shown in FIG. 1, the top plate 122 has four illumination openings 126 in total, with two in its right portion (one at the front and the other at the rear) and the other two in its left portion (one at the front and the other at the rear). The positions of the illumination openings 126 are not limited to the positions shown in the figure and are determined as appropriate based on the positions of the illuminators 16. The illumination openings 126 may not be four illumination openings 126, but may be three or fewer or five or more illumination openings 126. The number of illumination openings 126 is determined based on the number of illuminators 16 in the imaging device 10.

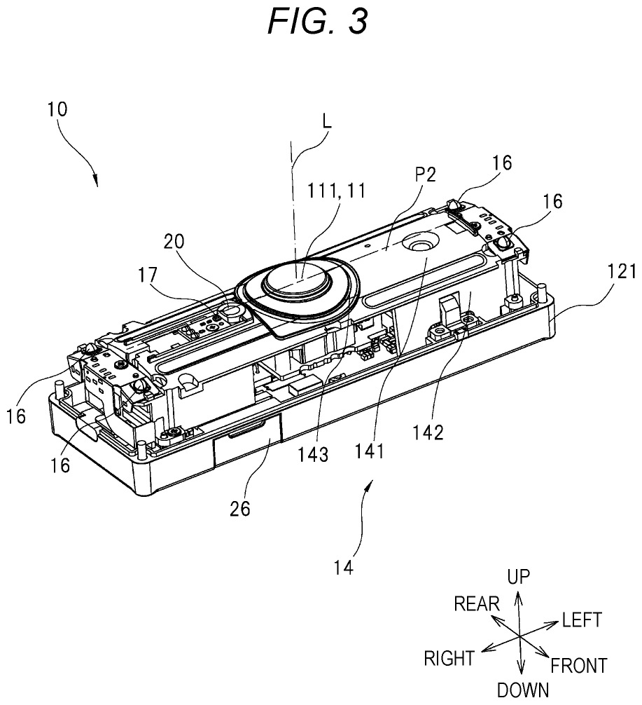

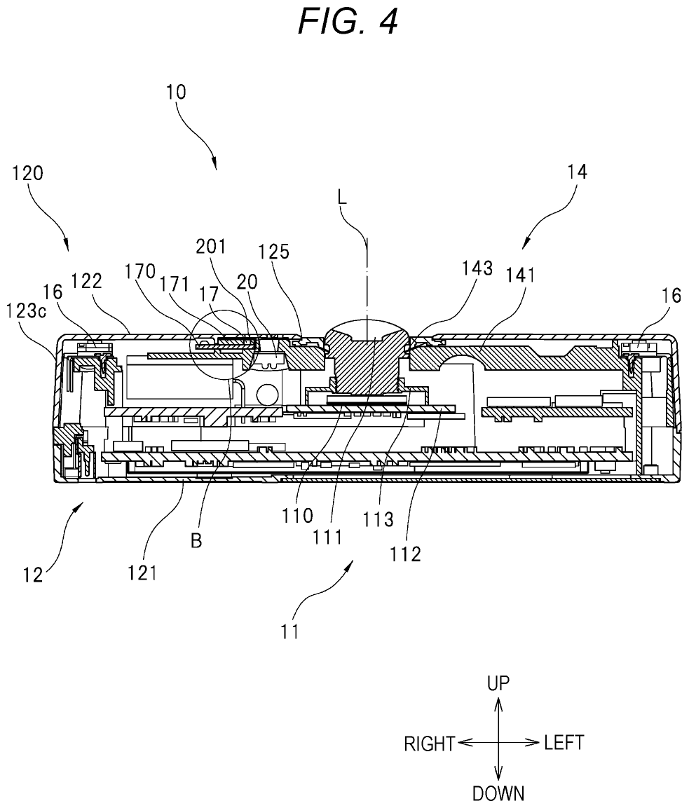

The top plate 122 of the front case 120 has multiple circular sound collecting openings 201 rightward from the case opening 125 on or around the first reference position P1. The sound collecting openings 201 are above a sound collector 20 described later (refer to FIGS. 3 and 4).

FIG. 2 is a perspective view of the front case 120 as viewed from below. The top plate 122 has an inner wall surface with a compartment 124 located rightward from the sound collecting openings 201. The compartment 124 is an inner area surrounded by walls 124a, 124b, and 124c protruding downward from the inner wall surface of the top plate 122. The wall 124a is located frontward from the first reference position P1 (refer to FIG. 1) and extends in the right-left direction. The wall 124c is located rearward from the first reference position P1 and extends in the right-left direction. A light shield 171 is fitted and accommodated in the compartment 124. The light shield 171 restricts entry of light into an illuminometer 17 (described later) through the side surface of the illuminometer 17.

The rear case 121 shown in FIG. 1 is fastened to the front case 120 and closes the bottom (downward) of the front case 120. The rear case 121 is fastened to the front case 120 with, for example, screws.

### Memory Slot 26

The imaging device 10 includes the memory slot 26 connectable to a predetermined storage medium. More specifically, the imaging device 10 includes a slot in which a secure digital (SD) memory card is removably placed. The SD memory card can be placed into or removed from the memory slot 26 after a lid in the rear case 121 is opened.

### Internal Structure of Imaging Device 10

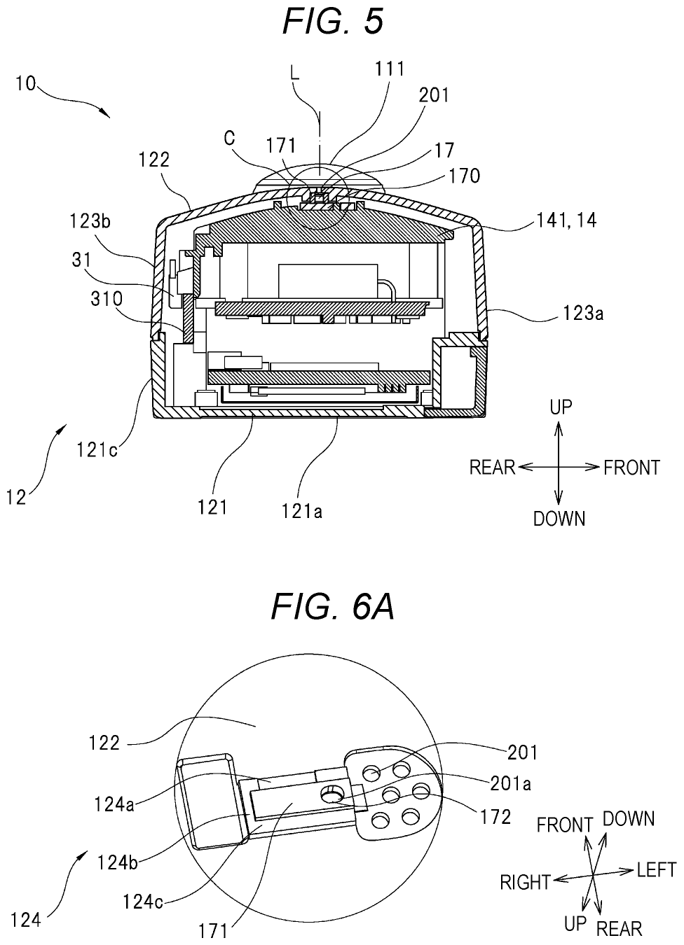

FIG. 3 is an internal perspective view of the imaging device 10 shown in FIG. 1. FIG. 4 is a cross-sectional view of the imaging device 10 shown in FIG. 1 taken along line A-A. FIG. 5 is a cross-sectional view of the imaging device 10 shown in FIG. 1 taken along line B-B. The imaging device 10 includes a support 14, the illuminometer 17, and the sound collector 20 in addition to the components described above.

### Camera Module 11

The camera module 11 includes an imaging element (image sensor) 110, such as a complementary metal-oxide-semiconductor (CMOS) or a charge-coupled device (CCD), and the lens 111. The imaging element 110 is mounted on a substrate 112 and accommodated in the housing 12. The lens 111 is located above the imaging element 110 and held by a lens holder 113. The lens 111 held by the lens holder 113 protrudes upward from the top plate 122 through the case opening 125 in the top plate 122 of the housing 12 described above. Below the lens holder 113, the substrate 112 on which the above imaging element 110 is mounted is fastened with, for example, screws.

The lens 111 guides and collects external subject light reaching the imaging device 10 to a light-receiving surface of the imaging element 110. In other words, the lens 111 is an optical member (imaging optical system) that forms an image of an imaging target on the light-receiving surface of the imaging element 110, or at least a part of the optical member. The imaging element 110 converts the brightness of light for the image formed by the lens 111 to electric charge and outputs a signal (image signal) corresponding to the resultant electric charge.

### Illuminator 16

The illuminators 16 emit illumination light to illuminate the imaging target (subject) for imaging in a dark surrounding external environment (or in the low-light imaging mode). The illuminators 16 each include an illumination light source such as a light-emitting diode (LED) and emit light with a wavelength in the infrared region (infrared rays or infrared light) under control of a controller 31 (described later). The illuminators 16 may not emit infrared light as illumination light, and may emit visible light other than infrared light as illumination light.

As shown in FIGS. 1 and 3, the imaging device 10 includes four illuminators 16. Of the four illuminators 16, a pair of illuminators 16 are located in a right portion of the support 14 (described later), with one illuminator 16 located at the front and the other illuminator 16 at the rear. The other pair of illuminators 16 are located in a left portion of the support 14, with one illuminator 16 located at the front and the other illuminator 16 at the rear.

The imaging device 10 May not include four illuminators 16. The imaging device 10 may include three or fewer illuminators 16 or five or more illuminators 16.

### Illuminometer 17

The illuminometer 17, which is, for example, a photoresistor or a photodiode, receives light reaching from the external environment surrounding the imaging device 10. The illuminometer 17 is mounted on a substrate 170 adjacent to a second reference position P2 (refer to FIG. 3) on the support 14 (described later). The substrate 170 is located rightward from the sound collector 20. The sound collector 20 includes a microphone for collecting sounds around the imaging device 10 through the sound collecting openings 201. More specifically, the illuminometer 17 is located below the rightmost one of the multiple sound collecting openings 201 in the top plate 122 of the front case 120. The illuminometer 17 receives external light through the rightmost sound collecting opening 201. The illuminometer 17 converts the brightness of the received external light to electric charge and outputs a signal (luminance signal) corresponding to the resultant electric charge. In other words, the illuminometer 17 detects the brightness of the external environment surrounding the imaging device 10. The illuminometer 17 is surrounded by the light shield 171 that reduces light other than external light entering the illuminometer 17. The light shield 171 will be described in detail later.

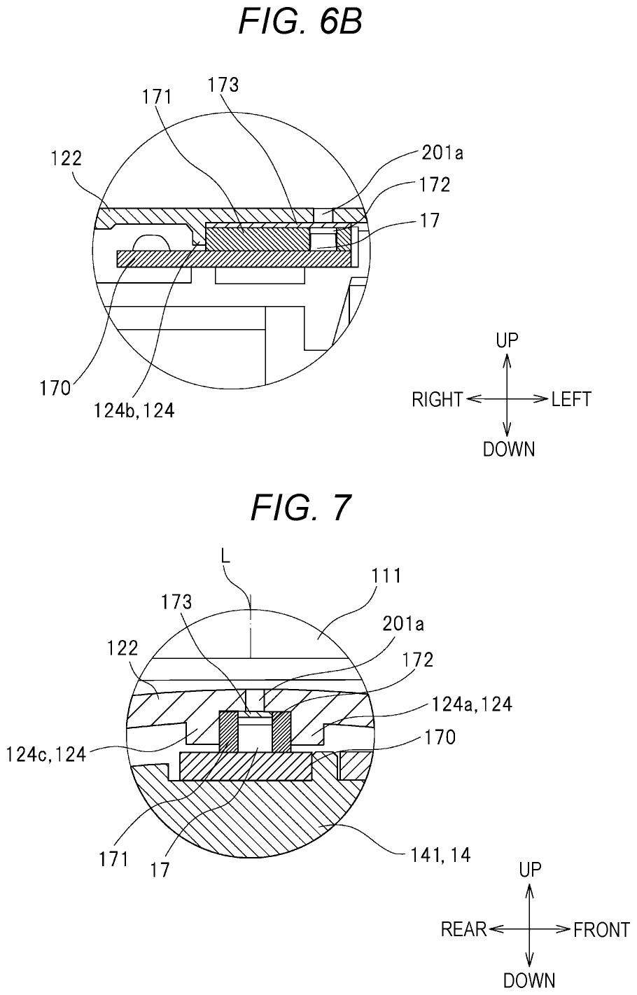

A light-transmissive filter 173 (refer to FIGS. 6B and 7) that transmits, for example, white light, is located between a light-receiving surface of the illuminometer 17 and the front case 120. The filter 173 transmits external light, allowing the light to reach the illuminometer 17, and reduces dust or other matter entering the imaging device 10 through the sound collecting openings 201. The filter 173 may be a bandpass filter that allows light in an intended wavelength range to pass through. The bandpass filter used as the filter 173 allows light in a wavelength region for detecting the brightness of the surrounding external environment to pass through, thus allowing accurate detection of the brightness of the surrounding external environment. The filter 173 may be eliminated.

### Controller 31

The controller 31 is located at the rear in the housing 12, and is mounted on a substrate 310. The controller 31 includes, for example, a central processing unit (CPU), a memory, and other components, and is electrically connected to the substrate 112 on which the imaging element 110 is mounted. The controller 31 is a processor that may read and execute a control program prestored in a storage medium, such as a flash memory, to control various components of the imaging device 10. For example, the controller 31 controls electric power supply from a power supply to various components including the imaging element 110.

Based on the luminance signal output from the illuminometer 17, the controller 31 sets the normal imaging mode when the external environment of the imaging device 10 is bright, and sets the low-light imaging mode when the external environment of the imaging device 10 is dark. In the low-light imaging mode, the controller 31 controls the illuminators 16 to emit illumination light to illuminate the subject with the illumination light when the external environment is dark and lacks a sufficient amount of light.

### Support 14

The support 14 is formed from, for example, a synthetic resin, and includes a main base 141 and a sub-base 142 integral with each other. The main base 141 is curved along or substantially along the curved front case 120. More specifically, the main base 141 is curved in the front-rear direction and protrudes most outward (upward) at the second reference position P2, which is on a line passing through a middle portion of the main base 141 (or a position through which the optical axis L of the lens 111 extends) and extending in the right-left direction. The second reference position P2 is parallel or substantially parallel to the first reference position P1 below the first reference position P1 of the front case 120 described above.

The sub-base 142 extends downward from the main base 141, and has a threaded hole for fastening the sub-base 142 to the rear case 121 with a screw. The sub-base 142 is fastened to the rear case 121 with the screw. This fastens the support 14 to the rear case 121.

The main base 141 has a circular or substantially circular main base opening 143 vertically extending through the support 14 with the optical axis L of the lens 111 at the center. In other words, the main base opening 143 is a through-hole in the main base 141. The lens 111 is placed in the main base opening 143.

The illuminators 16, the illuminometer 17, and the sound collector 20 are mounted on the upper surface of the main base 141. The main base 141 receives two illuminators 16 in its right portion and two illuminators 16 in its left portion. More specifically, the main base 141 receives one illuminator 16 at each of the front near the left end, the rear near the left end, the front near the right end, and the rear near the right end. The main base 141 receives the illuminometer 17 and the sound collector 20 adjacent to the second reference position P2 and rightward from the main base opening 143.

As described above, the main base 141 is curved and protrudes most upward at the second reference position P2 in the front-rear direction. The illuminometer 17 is thus located more upward than the illuminators 16 on the main base 141. In other words, the illuminators 16 are farther from the subject than the illuminometer 17 along the optical axis L.

### Light Shield 171

The light shield 171 will be described with reference to FIGS. 6A, 6B, and 7. FIG. 6A is an enlarged view of circled area A in FIG. 2. FIG. 6B is an enlarged view of circled area B in FIG. 4. FIG. 7 is an enlarged view of circled area C in FIG. 5.

As shown in the figures, the light shield 171 surrounds the illuminometer 17 in the front-rear and right-left directions. The light shield 171 is formed from an elastic material such as rubber or urethane. The light shield 171 may have surfaces coated with, for example, a light-absorbing material that absorbs light. The light shield 171 has a through-hole 172 extending through the light shield 171 in the vertical direction aligned with the position at which the illuminometer 17 is placed. Thus, the light shield 171 surrounds the illuminometer 17.

The light shield 171 is a rectangular prism corresponding to the shape of the compartment 124, with its long sides extending in the right-left direction. The light shield 171 is not limited to a rectangular prism, and may be, for example, a cube. The light shield 171 is attached to the compartment 124, or more specifically, to the inner wall surface of the top plate 122 of the front case 120, with, for example, an adhesive or double-sided tape. The light shield 171 that can be placed at the above position and bonded sufficiently firmly may have a shape with a larger upper surface to have a larger area of bonding to the top plate 122.

The light shield 171 has a length (height) in a direction along the optical axis L, or in the vertical direction, greater than the length (height) of the walls 124a, 124b, and 124c of the compartment 124 in the vertical direction. More specifically, the light shield 171 has a height greater than the distance in the vertical direction between the inner wall surface (lower surface) of the top plate 122 of the front case 120 and the substrate 170 on the main base 141 in the support 14. In response to the rear case 121 being attached to the front case 120, the light shield 171 formed from an elastic material contracts and deforms in the vertical direction under a force applied by the front case 120 from above and a force applied, from below, by the substrate 170 on which the illuminometer 17 is mounted. More specifically, the light shield 171 fills the space around the side surface of the illuminometer 17 between the front case 120 and the substrate 170 with a gap reduced between the lower surface of the light shield 171 and the upper surface of the substrate 170. With the reduced gap between the light shield 171 and the substrate 170, the light shield 171 can block light traveling toward the illuminometer 17 in the lateral direction of the illuminometer 17.

The light shield 171 reduces illumination light emitted from the illuminators 16, which are located downward from the illuminometer 17, and reflected by various internal components of the imaging device 10 entering in the lateral direction of the illuminometer 17. This allows the illuminometer 17 to receive external light entering through the front surface of (from above) the imaging device 10 and thus detect the brightness of the surrounding external environment accurately.

With the light shield 171 accommodated in the compartment 124 on the front case 120, the through-hole 172 is below the rightmost sound collecting opening 201a of the multiple sound collecting openings 201. In other words, the through-hole 172 is at the position at which the illuminometer 17 is located. The illuminometer 17 thus receives external light passing through the sound collecting opening 201a through the through-hole 172. The through-hole 172 blocks, on its side wall surface, external light obliquely entering the illuminometer 17, or more specifically, light traveling in a direction not parallel to the optical axis L of the lens 111. The illuminometer 17 thus does not receive such light. In other words, the through-hole 172 allows external light traveling along the optical axis L to pass through. The illuminometer 17 can thus receive external light entering through the front surface of (from above) the imaging device 10. The through-hole 172 may not be below the sound collecting opening 201a, and may be, in the light shield 171, below at least one of the multiple sound collecting openings 201.

The through-hole 172 is an elongated hole. The through-hole 172 has a minor axis with a length equal to or substantially equal to the diameter of the sound collecting opening 201a that is a circular hole. The through-hole 172 has a major axis with a length greater than the diameter of the sound collecting opening 201a. The through-hole 172 is larger than a light receiver in the illuminometer 17. The light shield 171 attached at a position misaligned in the right-left direction with respect to the top plate 122 of the front case 120 during manufacture is thus less likely to close the sound collecting opening 201a.

In FIG. 6A, the through-hole 172 has a major axis extending in the right-left direction. However, the through-hole 172 may have a major axis extending in the front-rear direction or in any other direction, rather than in the direction in the illustrated example. More specifically, the through-hole 172 may have a major axis extending in a direction in which the light shield 171 may be misaligned during attachment. The through-hole 172 may be a circular hole with a larger diameter than the sound collecting opening 201a to reduce the likelihood that the light shield 171 closes the sound collecting opening 201a. The through-hole 172 may be a circular hole similar to the sound collecting opening 201a instead of an elongated hole when the light shield 171 can be attached to the front case 120 without any misalignment between the through-hole 172 and the sound collecting opening 201a.

The structure according to the above embodiment produces at least one of the advantageous effects described below.

(1) The imaging device 10 includes the illuminometer 17 and the light shield 171. The illuminometer 171 is accommodated in the housing 12. The illuminometer 171 receives external light through the sound collecting opening 201a in the housing 12 and detects the brightness of the surrounding environment. The light shield 171 surrounds the illuminometer 17 and fills a space between the substrate 170 on which the illuminometer 17 is mounted and the housing 12 to block light. This structure reduces a gap between the light shield 171 and the substrate 170, thus allowing the light shield 171 to block light traveling toward the illuminometer 17 in the lateral direction of the illuminometer 17. In other words, this structure reduces the likelihood that the illuminometer 17 receives light emitted by other devices in the housing 12 and reflected by the internal components in the housing 12. The illuminometer 17 is thus less susceptible to ambient light and can have higher accuracy in detecting the brightness of the surrounding external environment. This structure reduces limitations on the positions of devices that emit light, thus increasing the design flexibility.

(2) The illuminators 16 emit illumination light to illuminate a subject. Each illuminator 16 is farther from the subject than the illuminometer 17 along the optical axis L of the lens 111. In other words, the illuminators 16 are located downward from the illuminometer 17. The light shield 171 reduces illumination light emitted from the illuminators 16, which are located downward from the illuminometer 17, and diffusely reflected by the various internal components of the imaging device 10 entering the illuminometer 17 in the lateral direction of the illuminometer 17. This structure can thus increase the positioning flexibility of the illuminators 16. The increased positioning flexibility of the illuminators 16 reduces limitations on the positions of the other devices and components in the imaging device 10, thus increasing the design flexibility.

(3) The light shield 171 is formed from an elastic material. The light shield 171 accommodated in the housing 12 thus easily deforms to correspond to the shapes of the top plate 122 of the front case 120 and the substrate 170. Thus, for the curved top plate 122, the light shield 171 can be located in tight contact with the top plate 122 of the front case 120 and the substrate 170.

(4) The light shield 171 has a length in the direction along the optical axis L (vertical direction) greater than the distance between the lower surface of the top plate 122 of the front case 120 in the housing 12 and the substrate 170 in the direction along the optical axis L (vertical direction). The light shield 171 attached to the front case 120 and accommodated in the housing 12 is deformed by the top plate 122 of the housing 12 and the substrate 170 in the direction along the optical axis L (vertical direction). The light shield 171 is thus located in tight contact with the top plate 122 and the substrate 170 and fills the space around the illuminometer 17 between the substrate 170 and the top plate 122 without a gap. This allows the light shield 171 to block light traveling toward the illuminometer 17 in the lateral direction of the illuminometer 17. The illuminometer 17 is thus less susceptible to ambient light and can have higher accuracy in detecting the brightness of the external environment.

(5) The light shield 171 has the through-hole 172 through which external light passes after passing through the sound collecting opening 201a in the housing. This structure allows the illuminometer 17 to receive external light and detect the brightness of the surrounding external environment, with entry of less ambient light.

(6) The through-hole 172 is an elongated hole. Thus, for the light shield 171 attached at a position misaligned in the right-left direction with respect to the top plate 122 of the front case 120 during manufacture, the light shield 171 is less likely to close the sound collecting opening 201a.

(7) The through-hole 172 allows external light traveling in the direction along the optical axis L to pass through. The illuminometer 17 can thus receive external light entering through the front surface of (from above) the imaging device 10.

(8) The light-transmissive filter 173 is located between the top plate 122 of the front case 120 in the housing 12 and the illuminometer 17. This structure can reduce dust or other matter entering the imaging device 10 through the sound collecting opening 201a without preventing external light from reaching the illuminometer 17.

Although various embodiments and modifications are described above, the present invention is not limited to the embodiments and the modifications. Other forms implementable within the scope of technical idea of the present invention fall within the scope of the present invention.

The light shield 171 may be attached to the substrate 170 instead of being attached to the front case 120. In this case as well, the light shield 171 may have a shape with a larger lower surface to have a larger area of bonding to the substrate 170. The light shield 171 may not be attached with its long sides extending in the right-left direction. For example, the light shield 171 may be attached with the long sides extending in the front-rear direction. The light shield 171 may be attached, as appropriate, in a direction appropriate for the positional relationship between the other components in the housing 12.

The technique according to one or more embodiments of the present invention may provide the structure described below.

(1) An imaging device, comprising:
a housing;
an imaging element accommodated in the housing, the imaging element being configured to receive subject light through an optical member;
an illuminometer accommodated in the housing, the illuminometer being configured to receive external light through an opening in the housing and detect brightness of a surrounding environment; and
a light shield surrounding the illuminometer, the light shield filling a space between a substrate on which the illuminometer is mounted and the housing to block light.

(2) The imaging device according to (1), further comprising:
an illuminator configured to emit illumination light to illuminate a subject,
wherein the illuminator is farther from the subject than the illuminometer in a direction along an optical axis of the optical member.

(3) The imaging device according to (1) or (2), wherein
the light shield comprises an elastic material.

(4) The imaging device according to any one of (1) to (3), wherein
the light shield has a dimension in a direction along an optical axis of the optical member greater than a distance between the housing and the substrate in the direction along the optical axis, and
the light shield accommodated in the housing is deformed by the housing and the substrate in the direction along the optical axis.

(5) The imaging device according to any one of (1) to (4), wherein
the light shield has a through-hole through which external light passes after passing through the opening in the housing.

(6) The imaging device according to (5), wherein
the through-hole is an elongated hole.

(7) The imaging device according to (5) or (6), wherein
the through-hole allows external light traveling in a direction along an optical axis of the optical member to pass through.

(8) The imaging device according to any one of (1) to (7), further comprising:
a light-transmissive filter between the housing and the illuminometer.

What is claimed is:

1. An imaging device, comprising:
a housing;
an imaging element accommodated in the housing, the imaging element being configured to receive subject light through an optical member;
an illuminometer accommodated in the housing, the illuminometer being configured to receive external light through an opening in the housing and detect brightness of a surrounding environment; and
a light shield surrounding the illuminometer, the light shield filling a space between a substrate on which the illuminometer is mounted and the housing to block light.

2. The imaging device according to claim 1, further comprising:
an illuminator configured to emit illumination light to illuminate a subject,
wherein the illuminator is farther from the subject than the illuminometer in a direction along an optical axis of the optical member.

3. The imaging device according to claim 1, wherein
the light shield comprises an elastic material.

4. The imaging device according to claim 3, wherein
the light shield has a dimension in a direction along an optical axis of the optical member greater than a distance between the housing and the substrate in the direction along the optical axis, and
the light shield accommodated in the housing is deformed by the housing and the substrate in the direction along the optical axis.

5. The imaging device according to claim 1, wherein
the light shield has a through-hole through which external light passes after passing through the opening in the housing.

6. The imaging device according to claim 5, wherein
the through-hole is an elongated hole.

7. The imaging device according to claim 5, wherein
the through-hole allows external light traveling in a direction along an optical axis of the optical member to pass through.

8. The imaging device according to claim 1, further comprising:
a light-transmissive filter between the housing and the illuminometer.

9. An imaging device, comprising:
a housing;
an imaging element accommodated in the housing, the imaging element being configured to receive subject light through an optical member;
an illuminometer accommodated in the housing, the illuminometer being configured to receive external light through an opening in the housing and detect brightness of a surrounding environment;
a light shield surrounding the illuminometer, the light shield filling a space between a substrate on which the illuminometer is mounted and the housing to block light;
an illuminator configured to emit illumination light to illuminate a subject; and
a light-transmissive filter between the housing and the illuminometer,
wherein the illuminator is farther from the subject than the illuminometer in a direction along an optical axis of the optical member,
the light shield comprises an elastic material,
the light shield has a dimension in the direction along the optical axis greater than a distance between the housing and the substrate in the direction along the optical axis,
the light shield accommodated in the housing is deformed by the housing and the substrate in the direction along the optical axis, and
the light shield has an elongated through-hole through which external light traveling in the direction along the optical axis passes after passing through the opening in the housing.
